(19) United States
(12) Patent Application Publication
(10) Pub. No.: US 2005/0004946 A1
(43) Pub. Date: Jan. 6, 2005

(54) Method for distributing contents

(76) Inventors: Yasushi Kawamoto, Yamato (JP); Eriko Koda, Yokohama (JP); Yasuyuki Ooki, Yokohama (JP); Tatsuya Kurioka, Tokyo (JP); Yusei Nishimoto, Tokyo (JP); Akitsugu Baba, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/847,880

(22) Filed: May 19, 2004

(30) Foreign Application Priority Data
May 19, 2003 (JP) 2003-140331

(51) Int. Cl. G06F 7/00

(52) U.S. Cl. 707/104.1

(57) ABSTRACT

A method of distributing contents in a system including a distribution station for distributing contents, a relay station for relaying the contents, a management apparatus for receiving the contents distributed from the distribution station or the relay station and managing the contents, and a plurality of terminal apparatuses for receiving the contents distributed from the management apparatus, the method comprising the steps of: attaching metadata to the contents distributed from the distribution station; and adding location information of the relay station, the management apparatus or each of the terminal apparatuses to the metadata of the contents when the contents are stored in the relay station, the management apparatus or the terminal apparatus. The contents can be displayed on the user side concentratedly regardless of locations of the contents so that the contents can be acquired or played back without user's consciousness of locations of the large number of contents.

### BACKGROUND OF THE INVENTION

1. Field of the Invention

The present invention relates to a method for distributing contents such as program, video or audio contents from a broadcasting station, a network distribution station or the like to users. Particularly, it relates to a technique for making it easy for users to use a plurality of contents distributed to the users.

2. Background Art

When contents are distributed from a broadcasting station or a network distribution station to a user, the user per se heretofore has to designate locations of contents consciously on the user side to perform a playback of the contents or an operation corresponding to the contents (such as reservation based on a program list, channel switching, playback based on a recorded image list, playback of purchased contents, etc.) on the basis of the locations of contents currently distributed or to be distributed in the future from the broadcasting station or the network distribution station or the locations of contents recorded or purchased by the user.

In the background art, Broadcast Markup

Language (BML) defined in Japanese standard ARIB STD B-24 “Data Coding and Transmission Specification for Digital Broadcasting” by the Association of Radio Industries and Businesses (ARIB), TV-Anytime Metadata defined in the metadata associated specification by the TV Anytime Forum, or the like, is used so that metadata indicating contents information are attached to contents distributed from the broadcasting station or the network distribution station, respectively. On the user side, the information concerning the contents is acquired and used.

In the aforementioned background art, when the user wants to use a plurality of contents distributed from the broadcasting station or the network distribution station, however, the user per se has to be conscious of locations of the plurality of contents. When the user wants to use the plurality of contents, there may arise a problem that it is troublesome to acquire or play back target contents.

Even in the case where metadata attached to the contents are distributed, locations of current contents cannot be acquired from such metadata information because the metadata information can be set only by the broadcasting station or the network distribution station as a distribution source of the contents and is constituted only by contents information such as information about the distribution source, names of the contents, outlines of the contents, video formats, and program information.

### SUMMARY OF THE INVENTION

An object of the present invention is to provide a method for distributing contents while attaching metadata indicating contents information to the contents respectively so that a database of metadata can be used in a user side apparatus for treating all the contents in the same way and for displaying the contents concentratedly on the user side regardless of locations of the contents on the basis of inquiry of an upper external apparatus about contents absent in the user side apparatus so that the user per se can acquire or play back the contents without user's consciousness of locations of the large number of contents.

According to an aspect of the present invention, there is provided a method of distributing contents, comprising the steps of: attaching metadata to contents respectively when distributing the contents; and adding location information of an apparatus having the contents stored therein to the metadata.

According to another aspect of the present invention, there is provided a method of distributing contents in a system including a distribution station for distributing contents, a relay station for relaying the contents, a management apparatus for receiving the contents distributed from the distribution station or the relay station and managing the contents, and a plurality of terminal apparatuses for receiving the contents distributed from the management apparatus, the method comprising the steps of: attaching metadata to the contents distributed from the distribution station; and adding location information of the relay station, the management apparatus or each of the terminal apparatuses to the metadata of the contents when the contents are stored in the relay station, the management apparatus or the terminal apparatus.

### BRIEF DESCRIPTION OF THE DRAWINGS

FIG. 1 is an explanatory diagram showing a method for distributing contents according to an embodiment of the present invention;

FIG. 2 is a configuration diagram showing an example of a system configuration for carrying out the method for distributing contents according to the embodiment of the present invention;

FIG. 3 is a diagram showing change in information of metadata when only the metadata are distributed in an embodiment of the present invention;

FIG. 4 is an explanatory diagram for explaining an operation after distribution of contents to a terminal apparatus in an embodiment of the present invention;

FIG. 5 is an explanatory diagram for explaining an operation in the case where contents are copied from a terminal apparatus to an external medium or another terminal apparatus in an embodiment of the present invention;

FIG. 6 is an explanatory diagram for explaining an operation in the case where an external medium is inserted into a terminal apparatus in an embodiment of the present invention;

FIG. 7 is an explanatory diagram for explaining an operation in the case where an external medium is ejected from a terminal apparatus in an embodiment of the present invention;

FIG. 8 is an explanatory diagram for explaining an operation in the case where contents are deleted from a terminal apparatus in an embodiment of the present invention;

FIG. 9 is an explanatory diagram for explaining an operation of using contents in the case where the contents are stored in a terminal apparatus in an embodiment of the present invention;

FIG. 10 is an explanatory diagram for explaining an operation of using contents in the case where the contents are stored in a management apparatus in an embodiment of the present invention; and

FIG. 11 is an explanatory diagram for explaining an operation of using contents in the case where the contents are stored in another terminal apparatus in an embodiment of the present invention.

### DETAILED DESCRIPTION OF THE INVENTION

An embodiment of the present invention will be described below in detail with reference to the drawings. Incidentally, in all the drawings for describing the embodiment, like parts refer to like numerals for the sake of omission of duplicated description.

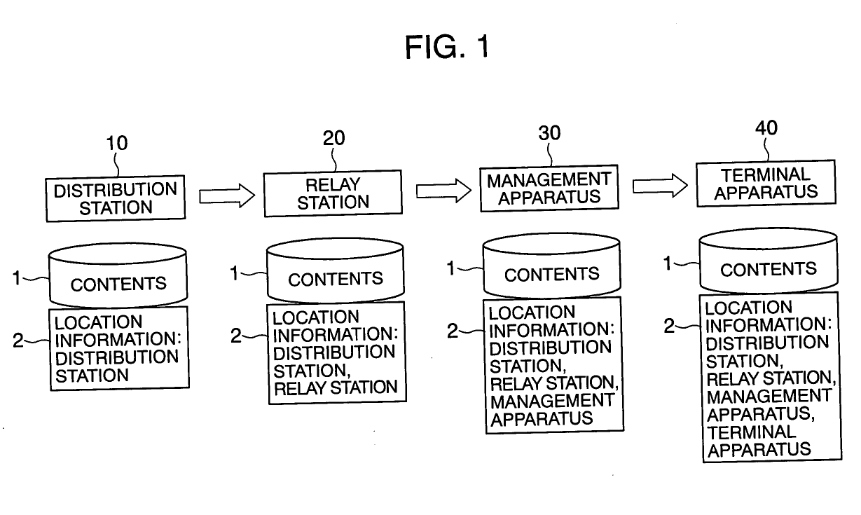

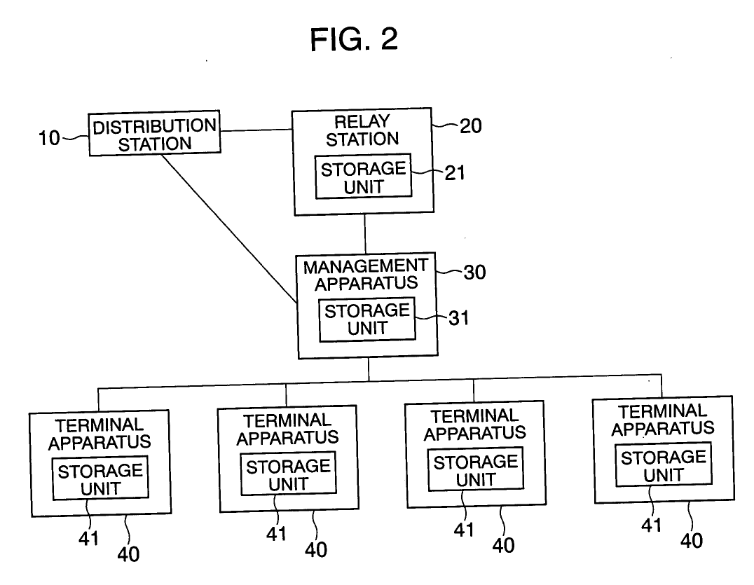

FIG. 1 is an explanatory diagram showing a method for distributing contents according to an embodiment of the present invention. FIG. 2 is a configuration diagram showing an example of a system configuration for carrying out the method for distributing contents according to the embodiment of the present invention.

In FIG. 1, metadata 2 including information of contents 1 distributed from a distribution station 10, and location information of the contents 1 are attached to the contents 1 respectively. In the distribution station 10, location information indicating the location of the distribution station 10 is added to the metadata 2 of the contents 1 when the contents 1 are distributed.

The location information is constituted by information such as the IP address of the distribution station 10 which can be used for specifying the distribution station 10. Similarly, a relay station 20, a management apparatus 30 and a terminal apparatus 40 can be identified by location information different from one another. When the contents 1 are stored in the relay station 20, the management apparatus 30 or the terminal apparatus 40, location information indicating the location of the relay station 20, the management apparatus 30 or the terminal apparatus 40 is added to the metadata 2 of the contents 1.

In FIG. 2, a system for carrying out the method for distributing contents includes: a distribution station 10 such as a broadcasting station or a network distribution station for distributing contents 1; a relay station 20 for distributing the contents 1 while collectively managing the contents 1 distributed from the distribution station 10 or relaying the contents 1 while caching the contents 1 distributed from the distribution station 10; a management apparatus 30 such as a home gateway or a home server for receiving the contents 1 distributed from the distribution station 10 or the relay station 20 and managing the contents 1; and a plurality of terminal apparatuses 40 through which users use the contents 1.

The relay station 20, the management apparatus 30 and each terminal apparatus 40 have storage units 21, 31 and 41 respectively. Information of contents 1 and metadata 2 attached to the contents 1 are stored in each of the storage units 21, 31 and 41. In each of the storage units 21, 31 and 41, the information of metadata 2 is stored in the form of a database in accordance with the contents 1.

When the quantity of the contents 1 stored in the storage unit 21 or 31 of the relay station 20 or management apparatus 30 exceed the capacity of the storage unit 21 or 31, old contents 1 are deleted or contents 1 low in access frequency are deleted.

Next, the metadata 2 attached to the contents 1 will be described.

For example, the metadata 2 attached to the contents 1 include contents information such as contents reference ID (CRID) for specifying the contents 1 based on the metadata associated specification defined by the TV Anytime Forum, outlines of the contents 1, video formats of the contents 1, and program information of the contents 1.

In this embodiment, the metadata 2 include location information which is information of a location where the contents 1 are stored currently, as well as the information of the contents. The location information can be added or deleted not only by the distribution station 10 but also by another apparatus such as the relay station 20, the management apparatus 30 or any one of the terminal apparatuses 40 in which the contents 1 can be stored.

Next, an operation in this embodiment will be described.

First, change in information of metadata 2 when contents 1 are distributed from the distribution station 10 to a terminal apparatus 40 will be described.

As shown in FIG. 1, location information of the distribution station 10 is added as information of the metadata 2 to the contents 1 distributed from the distribution station 10.

When the contents 1 distributed from the distribution station 10 are received by the relay station 20 and stored in the relay station 20, location information of the relay station 20 is added to the information of the metadata 2 of the contents 1.

Similarly, when the contents 1 are stored in the management apparatus 30, location information of the management apparatus 30 is added to the information of the metadata 2 of the contents 1. When the contents 1 are stored in each of the terminal apparatuses 40, location information of the terminal apparatus 40 is added to the information of the metadata 2 of the contents 1.

In this manner, the metadata 2 of the contents 1 distributed to the terminal apparatus 40 include the location information about the sites (such as the distribution station 10, the relay station 20, the management apparatus 30 and the terminal apparatus 40) where the contents 1 are stored. Accordingly, the terminal apparatus 40 can acquire the information of the contents 1 inclusive of the sites where the contents 1 are stored.

Next, an operation in the case of distribution of not the contents 1 per se but information of the metadata 2 such as program information or a program list attached to the contents 1 will be described.

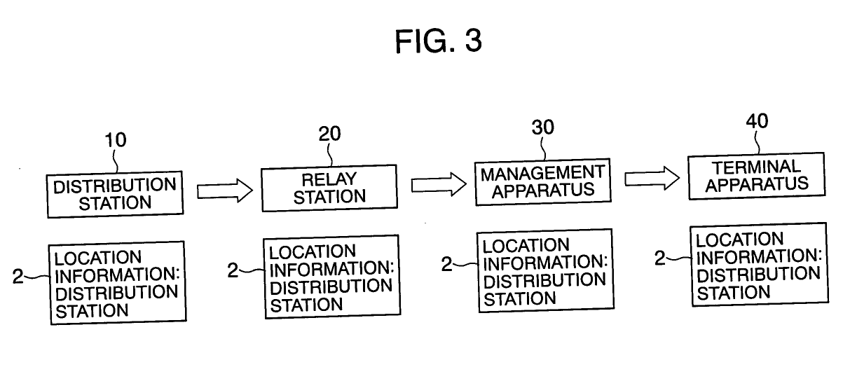

FIG. 3 is a diagram showing change in information of metadata in the case of distribution of only the metadata.

As shown in FIG. 3, location information of the distribution station is added as information of the metadata 2 distributed from the distribution station 10 in the case of distribution of not the contents 1 per se but the information of the metadata 2 attached to the contents 1.

When the metadata 2 distributed from the distribution station 10 are received by the relay station 20 but the contents 1 corresponding to the metadata 2 received by the relay station 20 are not stored in the relay station 20, location information of the relay station 20 is not added but location information of the distribution station 10 remains as the information of the metadata 2.

Similarly, when the contents 1 corresponding to the metadata 2 are not stored in the management apparatus 30, location information of the management apparatus 30 is not added but location information of the distribution station 10 remains as the information of the metadata 2. Similarly, when the contents 1 corresponding to the metadata 2 are not stored in each terminal apparatus 40, location information of the terminal apparatus 40 is not added but location information of the distribution station 10 remains as the information of the metadata 2.

When the contents 1 corresponding to the received metadata 2 are stored in the relay station 20, the management apparatus 30 or the terminal apparatus 40, location information of the relay station 20, the management apparatus 30 or the terminal apparatus 40 is added to the metadata 2 in the same manner as the metadata 2 shown in FIG. 1.

Next, an operation after distribution of the contents 1 to a terminal apparatus 40 will be described.

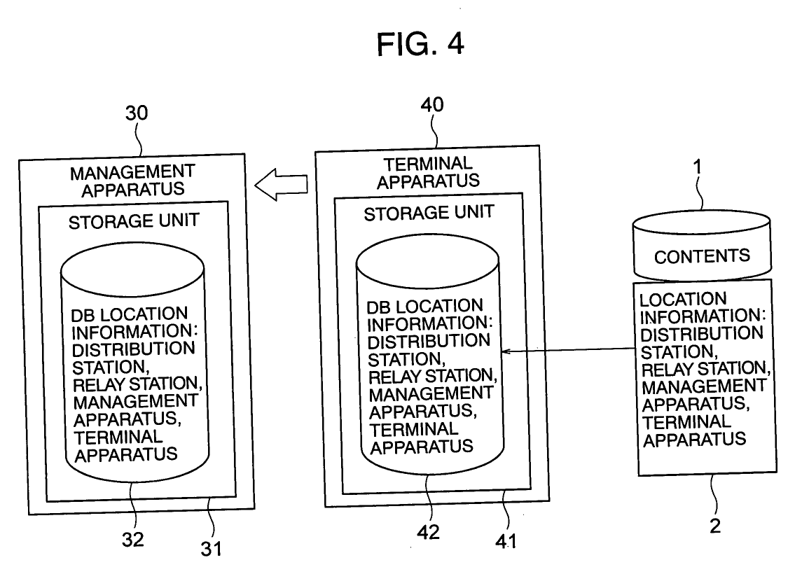

FIG. 4 is an explanatory diagram for explaining the operation after distribution of contents to a terminal apparatus.

In FIG. 4, the storage unit 31 of the management apparatus 30 and the storage unit 41 of the terminal apparatus 40 have databases 32 and 42 respectively. Information of metadata 2 attached to the contents 1 is stored in each of the databases 32 and 42.

First, as shown in FIG. 4, the metadata 2 attached to the contents 1 received by the terminal apparatus 40 include information of from the distribution station 10 to the terminal apparatus 40 stored as location information. In the terminal apparatus 40, the contents 1 are stored in the storage unit 41 while the information of the metadata 2 attached to the contents 1 is stored in the database 42 in the storage unit 41 in accordance with the contents 1.

The terminal apparatus 40 notifies the management apparatus 30 of the fact that new contents 1 have been stored. In the management apparatus 30, location information of the contents 1 is added to the database 32 in the storage unit 31 on the basis of the information notified by the terminal apparatus 40.

Accordingly, the location information of the contents 1 stored in the terminal apparatus 40 connected to the management apparatus 30 can be managed by the management apparatus 30.

Next, an operation when the contents 1 are copied from the terminal apparatus 40 to an external recording medium such as a video tape or a DVD or to another terminal apparatus 40 will be described.

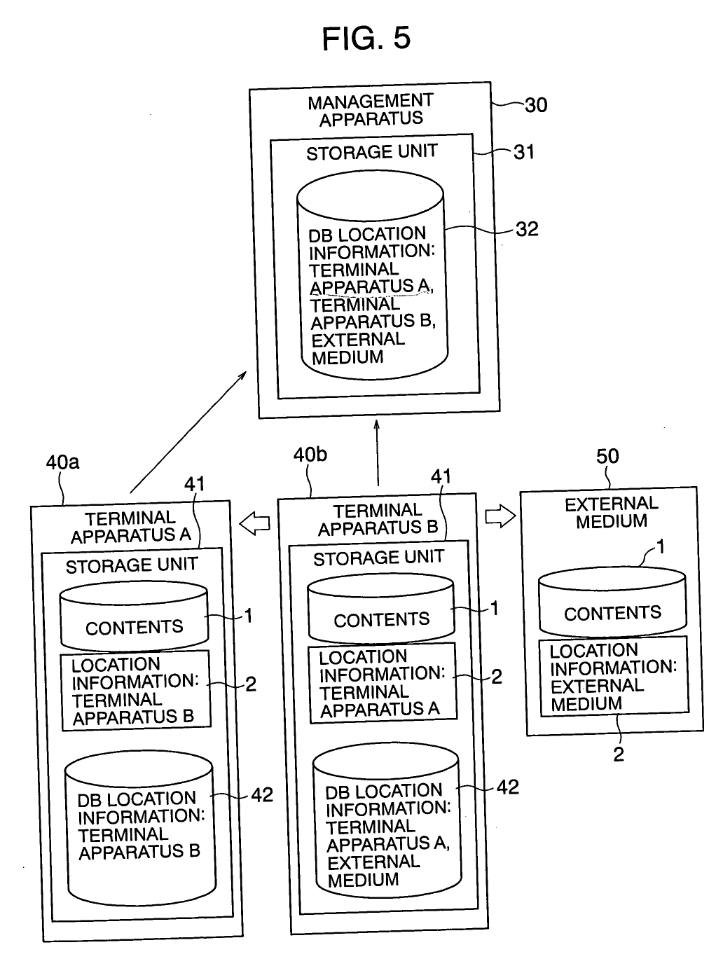

FIG. 5 is an explanatory diagram for explaining an operation when contents are copied from a terminal apparatus to an external recording medium or another terminal apparatus.

FIG. 5 shows a state in which contents 1 stored in a terminal apparatus A 40a are copied to an external medium 50 and another terminal apparatus B 40b. In an example shown in FIG. 5, only location information of the terminal apparatus A 40a is contained in information of metadata 2 attached to the contents 1 stored in the terminal apparatus A 40a.

First, when the contents 1 stored in the terminal apparatus A 40a are copied to the external medium 50, only location information of the external medium 50 is stored as the information of metadata 2 attached to the contents 1 copied to the external medium 50, because the external medium 50 may be used in terminal apparatuses 40 connected to another management apparatus 30.

In the terminal apparatus A 40a, the location information of the external medium 50 is added to the database 42 in the storage unit 41 of the terminal apparatus A 40a and notifies the management apparatus 30 of the fact that the contents 1 have been copied to the external medium 50. In the management apparatus 30, location information of the contents 1 is added to the database 32 in the storage unit 31 of the management apparatus 30 on the basis of the information sent from the terminal apparatus A 40a.

When the contents 1 stored in the terminal apparatus A 40a are copied to the terminal apparatus B 40b, the following operation is carried out. In the terminal apparatus B 40b, information of the terminal apparatus B 40b is added, in place of the location information of the terminal apparatus A 40a, to the metadata 2 attached to the contents 1 after the contents 1 are copied. The terminal apparatus B 40b adds the location information of the terminal apparatus B 40b to the database 42 in the storage unit 41 of the terminal apparatus B 40b and notifies the management apparatus 30 of the fact that the contents 1 have been copied to the terminal apparatus B 40b. In the management apparatus 30, the location information of the contents 1 is added to the database 32 in the storage unit 31 on the basis of information sent from the terminal apparatus B 40b.

Next, an operation when an external medium 50 is inserted into a terminal apparatus 40 or when the external medium 50 is ejected from the terminal apparatus 40 will be described.

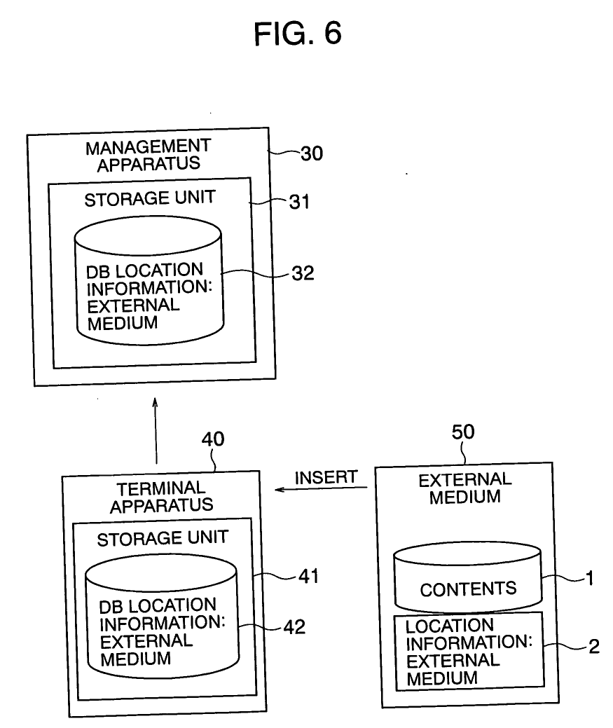

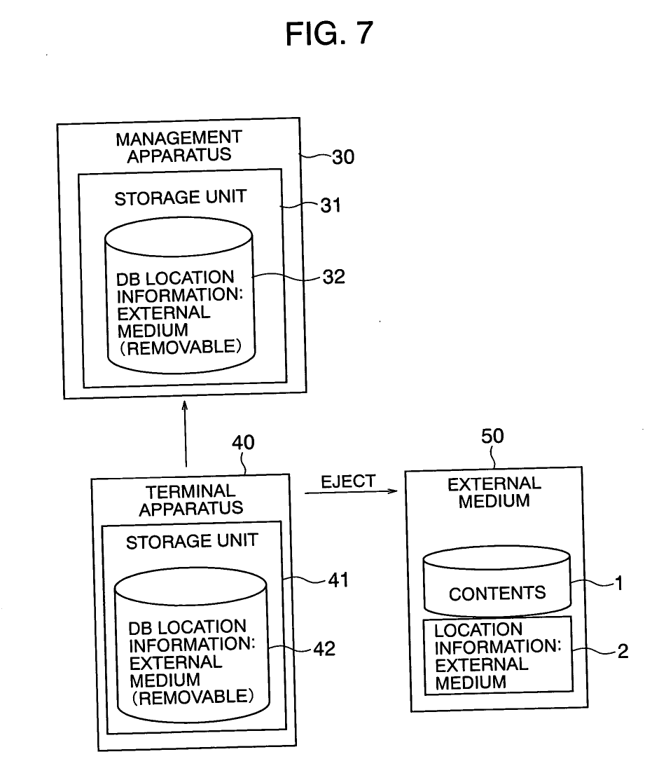

FIG. 6 is an explanatory diagram for explaining an operation when the external medium is inserted into the terminal apparatus. FIG. 7 is an explanatory diagram for explaining an operation when the external medium is ejected from the terminal apparatus.

First, when the external medium 50 is inserted into the terminal apparatus 40, the terminal apparatus 40 checks metadata 2 attached to contents 1 stored in the external medium 50, adds location information of the external medium 50 to the database 42 in the storage unit 41 of the terminal apparatus 40 and notifies the management apparatus 30 of the fact that the external medium 50 has been inserted into the terminal apparatus 40. In the management apparatus 30, the location information of the external medium 50 is added to the database 32 in the storage unit 31 on the basis of the information sent from the terminal apparatus 40.

When the external medium 50 is inserted into the terminal apparatus 40 and the contents 1 stored in the external medium 50 are stored in the terminal apparatus 40, the terminal apparatus 40 adds location information of the terminal apparatus 40 to the database 42 in the storage unit 41 and notifies the management apparatus 30 of the fact that the contents have been stored in the terminal apparatus 40. In the management apparatus 30, the location information of the content 1 is added to the database 32 in the storage unit 31 on the basis of the information sent from the terminal apparatus 40.

When the external medium 50 is ejected from the terminal apparatus 40, the terminal apparatus 40 retrieves the contents 1 stored in the ejected external medium 50 from the database 42 in the storage unit 41 and writes data in the database 42 in the storage unit 41 for indicating the fact that the external medium 50 has been ejected though the location information of the external medium 50 is kept as it is. Further, the terminal apparatus 40 notifies the management apparatus 30 of the fact that the external medium 50 has been ejected. The management apparatus 30 writes data in the database 32 in the storage unit 31 on the basis of the information sent from the terminal apparatus 40 for indicating the fact that the external medium 50 has been ejected though the location information of the external medium 50 is kept as it is.

Next, an operation when contents 1 are deleted from a terminal apparatus 40 will be described.

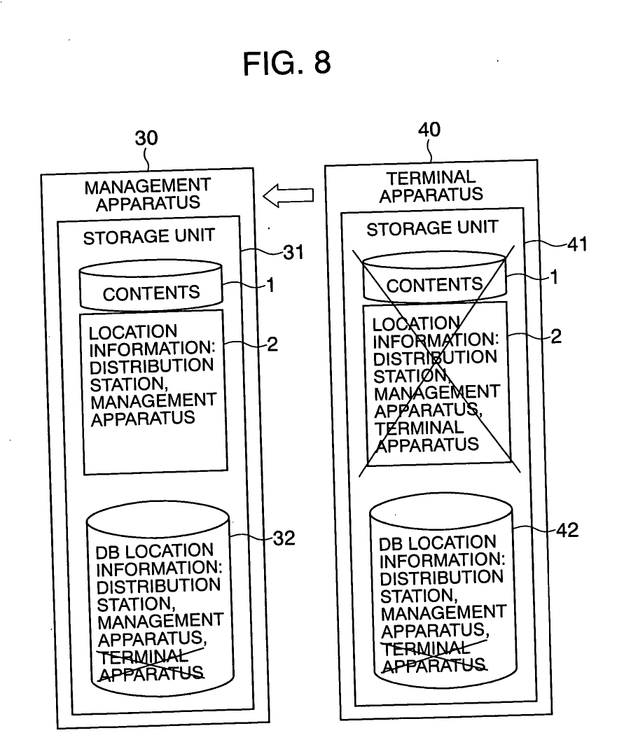

FIG. 8 is an explanatory diagram for explaining an operation when contents are deleted from a terminal apparatus.

When the contents 1 are deleted from the terminal apparatus 40, the terminal apparatus 40 retrieves the deleted contents 1 from the database 42 in the storage unit 41 of the terminal apparatus 40 and deletes location information of the terminal apparatus 40 from the database 42 in the storage unit 41. When there is no location information of the upper management apparatus 30, etc. as a result of the deletion, the terminal apparatus 40 deletes information of the contents 1 per se from the database 42.

The terminal apparatus 40 then notifies the management apparatus 30 of the fact that the contents 1 have been deleted. In the management apparatus 30, the location information of the terminal apparatus 40 is deleted from the database 32 in the storage unit 31 on the basis of the information sent from the terminal apparatus 40.

Next, use of contents 1 in a terminal apparatus 40 will be described.

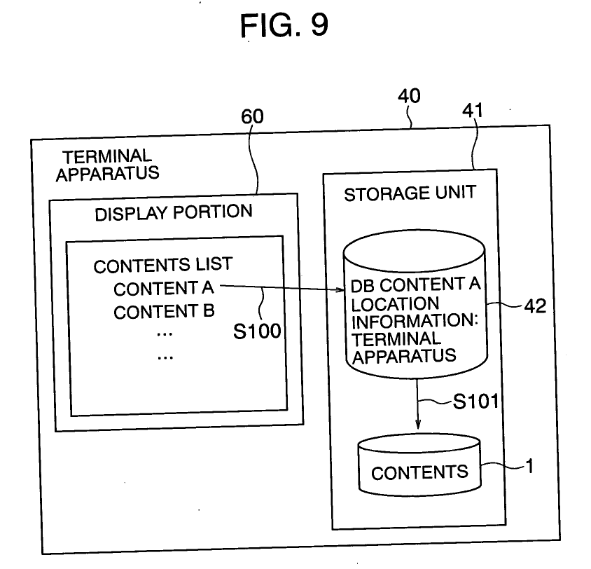

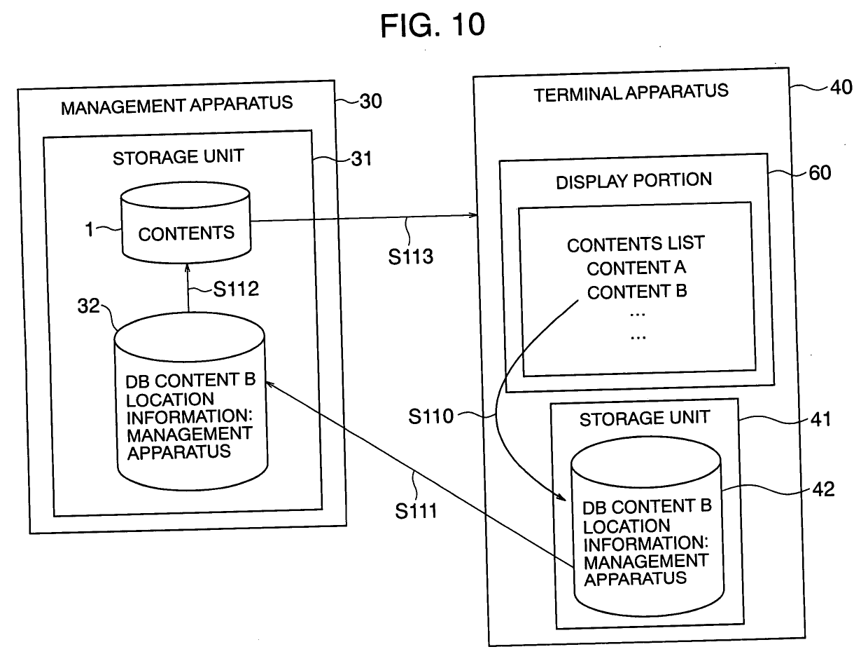

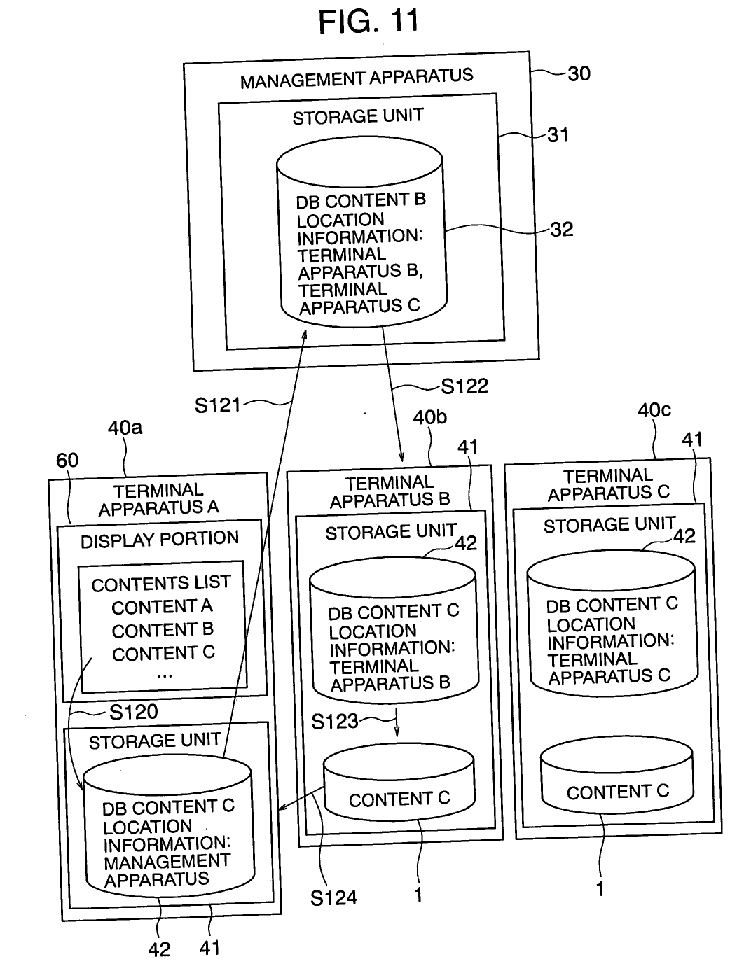

FIG. 9 is an explanatory diagram for explaining an operation of using contents in the case where the contents are stored in the terminal apparatus. FIG. 10 is an explanatory diagram for explaining an operation of using contents in the case where the contents are stored in the management apparatus. FIG. 11 is an explanatory diagram for explaining an operation of using contents in the case where the contents are stored in another terminal apparatus.

In each of FIGS. 9 to 11, the terminal apparatus 40 has a display portion 60 for displaying a list of contents 1, etc.

First, on the terminal apparatus 40 side, contents 1 allowed to be used by the current user are displayed, as a list of contents equivalent to one another as shown in FIGS. 9 to 11, on the display portion 60 or the like on the basis of contents information stored in the database 42 in the storage unit 41 of the terminal apparatus 40.

When the contents 1 are stored in the terminal apparatus 40 and the user selects a content (e.g. content A) from the list of contents 1 stored in the database 42 in the storage unit 41 as shown in FIG. 9, the user acquires location information from the contents information corresponding to the content A stored in the database 42 in the storage unit 41 (S100).

When the location information of the content A indicates only the terminal apparatus 40 as shown in FIG. 9, the content 1 identified by the content A stored in the storage unit 41 of the terminal apparatus 40 is played back (S101).

When the contents 1 are stored in the management apparatus 30 and the user selects a content (e.g. content B) from the list of contents 1 as shown in FIG. 10, the user acquires location information from the contents information corresponding to the content B stored in the database 42 in the storage unit 41 (S110).

When the location information for the content B indicates only the management apparatus 30 as shown in FIG. 10, the terminal apparatus 40 requests the management apparatus 30 to distribute the corresponding content 1 (S111).

Upon reception of the distribution request, the management apparatus 30 acquires location information from the contents information corresponding to the content B stored in the database 32 in the storage unit 31. When a content 1 in association with the location information of the content B is present in the management apparatus 30, the management apparatus 30 performs a process of distributing the content 1 (S112) and distributes the content 1 to the terminal apparatus 40 (S113). In the terminal apparatus 40, plays back the distributed content 1 is played back.

When the content based on the distribution request given from the terminal apparatus 40 and in association with the location information stored in the database 32 in the storage unit 31 is absent in the management apparatus 30, the distribution request is transferred to the upper relay station 20 or distribution station 10 where the content 1 is present, on the basis of the location information stored in the database 32 in the storage unit 31.

Upon reception of the transferred distribution request, the relay station 20 or distribution station 10 distributes the content 1 to the management apparatus 30 on the basis of the distribution request by the same operation as that of the management apparatus 30. In the management apparatus 30, the content 1 distributed from the upper relay station 20 or distribution station 10 is distributed to the terminal apparatus 40. In the terminal apparatus 40, the distributed content 1 is played back.

When a content 1 stored in the management apparatus 30 is deleted and absent from the management apparatus 30 but stored in another terminal apparatus 40, the user of a terminal apparatus A 40a can select a content (e.g. content C) from the list of contents 1 for acquiring location information from the contents information corresponding to the content C in the database 42 of the storage unit 41 of the terminal apparatus A 40a (S120).

When the location information of the content C indicates the management apparatus 30 as shown in FIG. 11, the user requests the management apparatus 30 to distribute the corresponding content 1 (S121).

Upon reception of the distribution request, the management apparatus 30 acquires location information from the contents information corresponding to the content C in the database 32 of the storage unit 31. When the content 1 in association with the location information of the content C is absent in the management apparatus 30 but present in a terminal apparatus B 40b and a terminal apparatus C 40c, the management apparatus 30 issues the request for distributing the corresponding content 1 to the most suitable site (e.g. terminal apparatus B 40b) (S122) on the basis of information such as location relation between the terminal apparatus A 40a and the terminal apparatus B 40b (the terminal apparatus C 40c), cost for distributing the content, network load for distributing the content, etc., for example, stored in the database 32 of the management apparatus 30 in advance.

Upon reception of the distribution request, the terminal apparatus B 40b acquires location information from the contents information corresponding to the content C in the database 42 in the storage unit 41 of the terminal apparatus B 40b and performs a process of distributing the content 1 (S123) on the basis of the location information of the content C. The terminal apparatus B 40b distributes the content 1 to the terminal apparatus A 40a directly or via the management apparatus 30 (S124). In the terminal apparatus A 40a, the distributed content 1 is played back.

Incidentally, when the content 1 is stored only in an external medium 50, a message for urging the user to insert the external medium 50 is issued so that the user can insert the external medium 50.

Next, an operation when a content 1 selected by a terminal apparatus 40 is to be distributed in the future will be described.

When information of contents 1 to be distributed in the future is stored in the database 42 of the storage unit 41 of the terminal apparatus 40 in accordance with program information, a program list, etc. to be distributed and a user selects one of the contents 1, the terminal apparatus 40 makes a reservation for distribution of the content 1. When it comes to the time for distribution, the terminal apparatus 40 sends a request for distributing the content 1 to the distribution source of the content 1 (e.g. the distribution station 10), for example, via the management apparatus 30 and plays back or stores the content 1 distributed in response to the request for distributing the content 1.

Next, an operation when a terminal apparatus 40 is additionally connected to the management apparatus 30 and an operation when the terminal apparatus 40 is disconnected from the management apparatus 30 will be described.

First, when a terminal apparatus 40 is connected to the management apparatus 30 through a network, etc. and added as a terminal apparatus 40 managed by the management apparatus 30, all contents information stored in the database 42 of the storage unit 41 of the terminal apparatus 40 is sent to the upper management apparatus 30 and the management apparatus 30 adds the information sent from the added terminal apparatus 40 to the database 32 of the storage unit 31.

The management apparatus 30 also sends contents information stored in the database 32 of the storage unit 31 to the terminal apparatus 40. The terminal apparatus 40 adds the information sent from the management apparatus 30 to the database 42 of the storage unit 41.

In this manner, the information of contents 1 stored in the newly added terminal apparatus 40 is stored in the database 32 of the storage unit 31 of the management apparatus 30 so that the management apparatus 30 can manage the contents 1 stored in the terminal apparatus 40. In addition, the information of the contents 1 stored in the management apparatus 30 is stored in the database 42 of the storage unit 41 of the terminal apparatus 40 so that the terminal apparatus 40 can use the contents 1 managed by the management apparatus 30.

When the terminal apparatus 40 is disconnected from the management apparatus 30, the terminal apparatus 40 deletes all the contents information from the database 42 of the storage unit 41 except the contents 1 originally stored in the terminal apparatus 40 per se.

When there is no response from the terminal apparatus 40, the management apparatus 30 deletes the location information of the non-respondent terminal apparatus 40 from the database 32 of the storage unit 31.

In this manner, the information of the contents 1 stored in the disconnected terminal apparatus 40 is deleted from the database 32 of the storage unit 31 of the management apparatus 30 so that the management apparatus 30 does not manage the disconnected terminal apparatus 40. On the other hand, the terminal apparatus 40 deletes all information except the information of the contents 1 originally stored in the terminal apparatus 40 per se, from the database 42 of the storage unit 41 of the terminal apparatus 40, so that the terminal apparatus 40 is not allowed to use contents 1 stored in any other apparatus, etc.

Incidentally, when the terminal apparatus 40 is disconnected from the management apparatus 30, the terminal apparatus 40 may delete all contents information except the contents 1 originally stored in the terminal apparatus 40 per se and contents 1 copied to the external medium 50, from the database 42 of the storage unit 41.

On this occasion, when a content 1 not stored in the terminal apparatus 40 is used, a message for urging the user to insert an external medium 50 may be issued so that the user can insert the external medium 50.

In this embodiment, when contents 1 such as programs, video or audio data, etc. are distributed from the distribution station 10 to a terminal apparatus 40 used by a user, location information of an apparatus such as the relay station 20, the management apparatus 30, etc. where the contents 1 are stored is stored in information of metadata 2 attached to the contents 1. Accordingly, the terminal apparatus 40 used by the user can acquire the locations of the contents 1 so that the contents can be displayed on the user side concentratedly regardless of the locations of the contents 1.

The contents can be acquired and played back without user's consciousness of locations of a large number of contents 1.

As described above, according to the present invention, when contents distributed from the distribution station are stored in the relay station, the management apparatus or the terminal apparatus while metadata are attached to the contents, location information of the relay station, the management apparatus or the terminal apparatus is added to the metadata of the stored contents. Accordingly, the terminal apparatus can acquire the locations of the contents so that the contents can be displayed on the terminal apparatus side concentratedly regardless of the locations of the contents.

In addition, the terminal apparatus can acquire and play back the contents regardless of user's consciousness of locations of a large number of contents.

It should be further understood by those skilled in the art that although the foregoing description has been made on embodiments of the invention, the invention is not limited thereto and various changes and modifications may be made without departing from the spirit of the invention and the scope of the appended claims.

1. A method of distributing contents, comprising the steps of:
attaching metadata to said contents respectively when distributing said contents; and
adding location information of an apparatus having said contents stored therein to said metadata.

2. A method of distributing contents in a system including a distribution station for distributing contents, a relay station for relaying said contents, a management apparatus for receiving said contents distributed from said distribution station or said relay station and managing said contents, and a plurality of terminal apparatuses for receiving said contents distributed from said management apparatus, said method comprising the steps of:
attaching metadata to said contents distributed from said distribution station; and
adding location information of said relay station, said management apparatus or each of said terminal apparatuses to said metadata of said contents when said contents are stored in said relay station, said management apparatus or said terminal apparatus.

3. A method of distributing contents according to claim 2, wherein a database is provided in each of said management apparatus and said terminal apparatus so that information of said metadata attached to said contents is stored in said database.

4. A method of distributing contents according to claim 3, wherein:
said management apparatus is notified of information of said contents when said contents are stored in said terminal apparatus; and
location information of said terminal apparatus is added to said database in said management apparatus in accordance with said information of said contents received in said management apparatus.

5. A method for distributing contents according to claim 4, wherein:
a list of said contents is displayed on said terminal apparatus on the basis of information stored in said database in said terminal apparatus; and
when said contents are selected, said contents are acquired on the basis of said information stored in said database in said terminal apparatus.

6. A method for distributing contents according to claim 3, wherein:
a list of said contents is displayed on said terminal apparatus on the basis of information stored in said database in said terminal apparatus; and
when said contents are selected, said contents are acquired on the basis of said information stored in said database in said terminal apparatus.
